(19) United States
(12) Patent Application Publication
(10) Pub. No.: US 2006/0215694 A1
(43) Pub. Date: Sep. 28, 2006

(54) Contention-free burst method for media access control over networks

(75) Inventor: Ho-Keng Lu, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/086,472

(22) Filed: Mar. 22, 2005

(51) Int. Cl. H04J 3/22; H04J 3/16

(52) U.S. Cl. 370/468

(57) ABSTRACT

A contention-free burst method for a media access controller to transmit data over a network. The first step is to create descriptors identifying multiple frames to be transmitted by a contention-free burst. Each descriptor comprises a semaphore field indicating whether the frame associated therewith is the last within the contention-free burst, and comprises an exchange time field recording duration of the frame associated therewith. The frames are transferred to a media access controller initiating the contention-free burst. The media access controller tracks an actual amount of elapsed time from when the burst is initiated. The contention-free burst is terminated either when a granted period less the actual amount of elapsed time results in insufficient time for any remaining transmission, or upon detection of a descriptor with a semaphore field indicating the last frame in which case termination is executed following transmission of the frame determined to be last.

### BACKGROUND

The invention relates to wireless local area networks (WLANs), and more particularly to a contention-free burst scheme for a media access controller to transmit data over a WLAN.

Wireless networks based on IEEE 802.11 have been widely adopted by home users and businesses. New applications such as video and multimedia streaming bring unique and challenging Quality of Service (QoS) requirements.

The ever-increasing demand for bandwidth has caused network congestion and slowdowns, but home users want multimedia distribution to work perfectly without dropouts or glitches. Network administrators need mechanisms to ensure that applications with stringent QoS requirements will function properly over a congested network. These issues have triggered the development of a QoS enhancement for the 802.11 WLAN. To enable QoS techniques to come to life in WLANs, the IEEE 802.11 committee is working on -the 802.11e standard. Currently in draft form, this standard defines changes to the operation of the 802.11 media access control (MAC) layer to enable prioritization and classes of service over a WLAN.

The IEEE 802.11 legacy MAC is based on two channel access mechanisms, called coordination functions, which determine when a station is permitted to transmit, and when it must be prepared to receive data. The mandatory mechanism is the distributed coordination function (DCF), which uses the Carrier Sense Multiple Access (CSMA) technique. The second coordination function is the point coordination function (PCF). Implementation of the PCF is an option, and it has not been widely implemented. 802.11e defines the hybrid coordination function (HCF) to replace the legacy DCF and PCF in a QoS station (QSTA). Within the HCF, there are two access mechanisms, the enhanced distributed channel access (EDCA) and HCF controlled channel access (HCCA). The HCF allocates the right to transmit through transmission opportunities (TXOPs) granted to QSTAs. A TXOP grants a particular QSTA the right to use the medium at a defined point in time, for a defined maximum duration. The allowed duration of TXOPs are communicated globally in the beacon for stations using EDCA. The HCF also introduces an optional feature called contention-free burst (CFB) that allows multiple MAC frame transmissions during a single TXOP. Rather than contending for the medium again as would be required in the legacy standard, 802.11e allows a station to resume transmitting after the short inter-frame space (SIFS) delay. CFBs are not explicitly listed as an optional feature of 802.11e, but a QoS station or access point (AP) may choose to use CFBs to improve efficiency by eliminating some contention. Studies have demonstrated that the CFB option is useful in increasing system throughput.

The duration of a CFB must be restricted within a granted TXOP limit. Conventionally, a software driver may aggregate frames, which aim to be transmitted via a CFB, and ensure that these frames can fit into a TXOP. When the frames are ready, the software driver passes them to the MAC layer for transmission using the CFB option. However, it is very difficult and inefficient to aggregate frames because a software driver cannot estimate when the next frame will arrive from a higher layer application. In view of the above, what is needed is a CFB mechanism enabling the MAC layer to transmit data frames over a WLAN, addressing the problems associated with the related art.

### SUMMARY

Embodiments of the present invention are generally directed, but not limited, to a contention-free burst method for a media access controller to transmit data over a network. According to one aspect of the invention, the first step of the method is to create a plurality of descriptors identifying frames to be transmitted by a contention-free burst. Each of the descriptors preferably comprises a semaphore field and an exchange time field, in which the semaphore field indicates whether the frame associated therewith is the last one within the contention-free burst, and the exchange time field records duration of the frame associated therewith. The frames are successively transferred to a media access controller, which initiates the contention-free burst to transmit the frame identified by the first descriptor. The media access controller continues using the contention-free burst to transmit subsequent frames identified by the corresponding descriptors. Meanwhile, the media access controller tracks an actual amount of elapsed time from when the contention-free burst is initiated. The contention-free burst can be terminated either when a granted period less the actual amount of elapsed time results in insufficient time for any remaining transmission according to the exchange time field of a current descriptor, or upon detection of a descriptor with a semaphore field indicating the last frame within the burst in which case termination is executed following transmission of the frame determined to be last.

Embodiments of the invention may also be embodied in sequences of instructions, which are represented by data stored on a machine-readable medium, for transmitting multiple frames over a network by a contention-free burst. The sequences of instructions, when executed by a processor, cause the processor to: create a plurality of descriptors identifying the frames to be transmitted by the contention-free burst, where each of the descriptors comprises a semaphore field indicating whether the frame associated therewith is the last one within the contention-free burst, and comprises an exchange time field recording a duration of the frame associated therewith; sequentially set the semaphore fields of the descriptors identifying the frames to be transmitted by the contention-free burst; count the number of the frames to be transmitted by the contention-free burst; calculate a cumulative sum of the frame durations recorded in the exchange time fields of the descriptors identifying the frames to be transmitted by the contention-free burst; clear the semaphore field of a descriptor identifying a current frame either upon the count reaching a predetermined number, or when the cumulative sum satisfies a predetermined condition; and successively transfer the frames to a media access controller for transmission of the frames using the contention-free burst.

### BRIEF DESCRIPTION OF THE DRAWINGS

The invention will be described by way of exemplary embodiments, but not limitations, illustrated in the accompanying drawings in which like references denote similar elements, and in which:

FIG. 1 is a block diagram illustrating the QoS station architecture in accordance with an embodiment of the invention;

FIG. 2 is a flowchart illustrating a contention-free burst method in accordance with an embodiment of the invention; and

FIGS. 3A and 3B are timing diagrams illustrating transmissions via contention-free bursts in accordance with an embodiment of the invention.

### DETAILED DESCRIPTION

With reference to the accompanying figures, exemplary embodiments will now be described. The exemplary embodiments are described primarily with reference to block diagrams and flowcharts. As to the flowcharts, each block within the flowcharts represents both a method step and an apparatus element for performing the method step. Herein, the apparatus element may be referred to as a means for, an element for, or a unit for performing the method step. Depending upon the implementation, the apparatus element, or portions thereof, may be configured in hardware, software, firmware or combinations thereof. As to the block diagrams, it should appreciated that not all components necessary for a complete implementation of a practical system are illustrated or described in detail. Rather, only those components necessary for a thorough understanding of the invention are illustrated and described. Furthermore, components which are either conventional or may be readily designed and fabricated in accordance with the teachings provided herein are not described in detail.

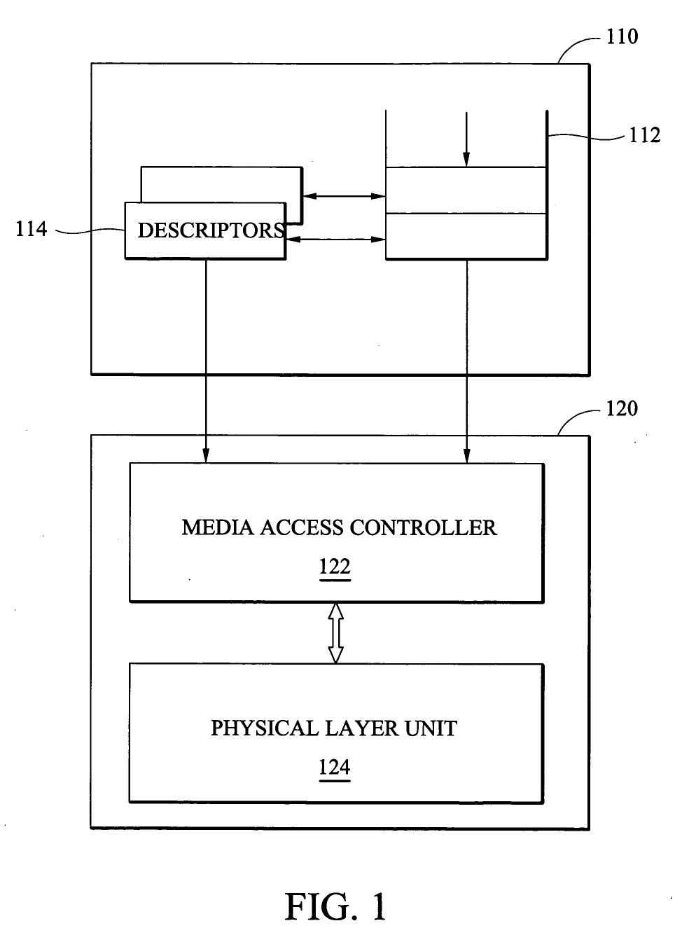

FIG. 1 illustrates a block diagram of the QoS station architecture in accordance with an embodiment of the invention. However, this is merely an example of the QoS station architecture and embodiments of the present invention are not limited in this respect. As depicted, the exemplary architecture comprises a processor 110 on which a software driver and higher layer application are hosted. The software driver has sequences of instructions in terms of data stored on a machine-readable medium. When executed, the sequences of instructions cause the processor 110 to maintain a transmit queue 112 and create one or more descriptors 114 targeting the queue. Although one queue is shown in FIG. 1, a particular processor may support any number of queues. The exemplary architecture of FIG. 1 also comprises a networking module 120 adapted to communicate with the processor 110. The networking module 120 enables the QoS station to transmit and receive data over a physical medium. The physical medium may be any one of several media suitable for data transmission according to a communication protocol, including, for example, coaxial cabling, twisted pair lines, optical fiber cabling, or a wireless medium. The networking module 120 comprises a media access controller 122 responsible for the MAC layer tasks and a physical layer unit 124 responsible for the PHY layer tasks.

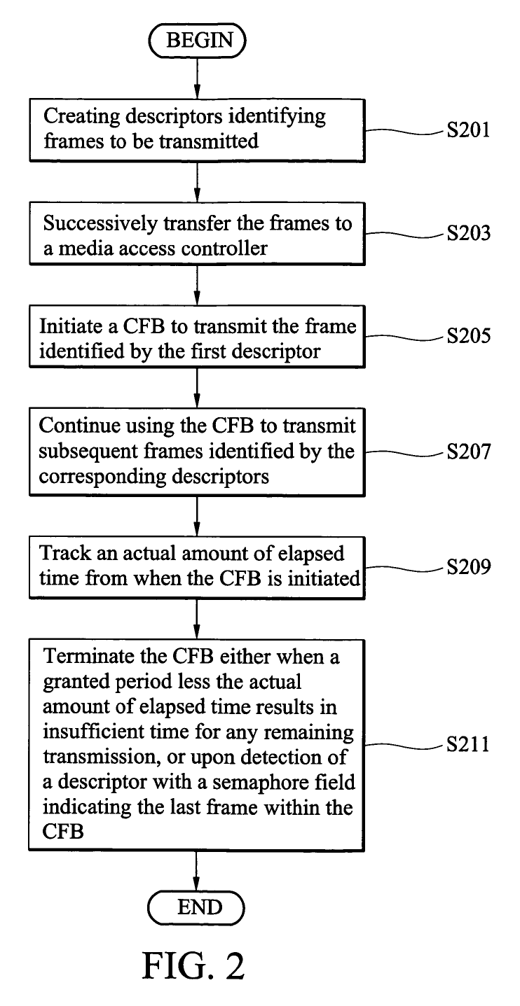

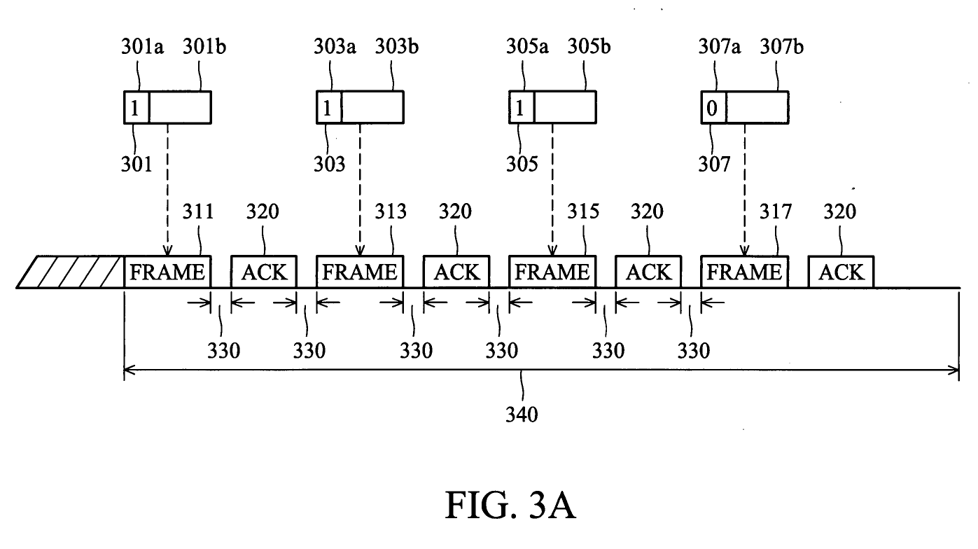

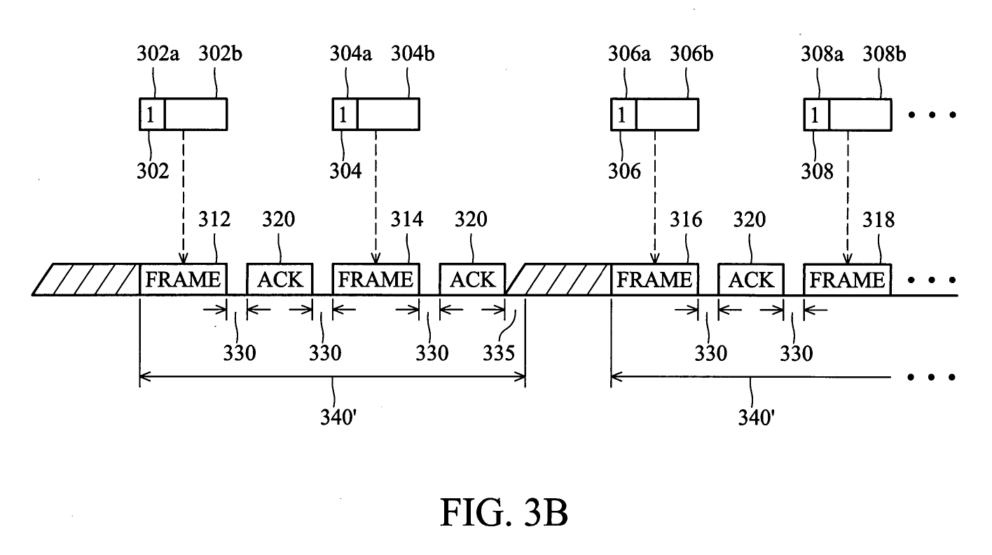

In operation, the software driver causes the processor 110 to deposit frames into the transmit queue 112 whenever a new frame to be transmitted arrives from the higher layer application. A contention-free burst method is now described from a flowchart of FIG. 2 in conjunction with timing diagrams of FIGS. 3A and 3B. Upon receipt of a frame, a descriptor identifying the frame is created in step S201. Each descriptor preferably comprises a semaphore field and an exchange time field, in which the semaphore field indicates whether the frame associated therewith aims to be transmitted by a contention-free burst (CFB), and the exchange time field records duration of the frame associated therewith. The semaphore field of a descriptor is set to logic ‘1’ in order to indicate an associated frame with intent to use a CFB. On the other hand, the exchange time field of a descriptor is filled in with the duration of a frame associated therewith by estimation based on a physical data rate and the length of the frame. If there are several frames to be transmitted during a CFB, the corresponding descriptors are sequentially created with the semaphore fields set and the exchange time fields filled in. In one embodiment, the processor 110 running the software driver counts the number of frames using the same CFB and calculates a cumulative sum of the frame durations recorded in the exchange time fields of the descriptors identifying these frames. Either upon the count reaching a predetermined number or when the cumulative sum satisfies a predetermined condition, the semaphore field of a descriptor identifying a currently arrived frame is cleared to logic ‘0’. As such, the semaphore field also indicates whether the frame associated therewith is the last one within the CFB. The predetermined number and condition are designed to manage the overall network throughput, in which the predetermined condition may be a maximum transmission time dictated by an administrator. In an alternative embodiment, the semaphore fields are always set to logic ‘1’ for consecutive frames with higher priority to transmit. Therefore, the number of frames is not necessarily counted and the calculation of the cumulative sum may be removed. However, these are merely examples of the usage of the semaphore fields and embodiments of the invention are not limited in this respect. With the semaphore fields, the software driver need not aggregate all frames for an entire CFB.

Still referring to FIG. 2, the frames to be transmitted are successively transferred to the media access controller 122 in step S203. Each frame from the queue 112 arrives at the media access controller 122 along with a descriptor. When detecting the first descriptor with a semaphore field set to logic ‘1’, the exemplary QoS station contends for the physical medium to prepare for a CFB. After the exemplary QoS station gains access to the medium, the media access controller 122 proceeds to step S205 where it initiates a CFB to transmit the frame identified by the first descriptor. Next in step S207, the media access controller 122 continues using the CFB without medium contention to transmit subsequent frames identified by the corresponding descriptors. Meanwhile, the media access controller 122 pursuant to step S209 tracks an actual amount of elapsed time from when the CFB is initiated. In step S211, the CFB can be terminated either when a granted period less the actual amount of elapsed time results in insufficient time for any remaining transmission according to the exchange time field of a current descriptor, or upon detection of a descriptor with a semaphore field indicating the last frame within the burst in which case termination is executed following transmission of the frame determined to be last. The granted period is the duration of a TXOP granted to the exemplary QoS station.

FIG. 3A shows the transmission of four frames 311-317 via a CFB within a TXOP 340 in accordance with an embodiment of the method. The frames 311 through 317 are identified by descriptors 301-307 with semaphore fields 301a-307a and exchange time fields 301b-307b, respectively. When the first frame 311 with the semaphore field 301a set to logic ‘1’ arrives, the media access controller 122 appreciates that there are multiple frames to be transmitted and initiates a CFB accordingly. For each successful reception of a frame, a receiving station immediately acknowledges by sending an ACK frame 320 after a SIFS 330. As depicted, several data frames can be transmitted and corresponding ACK frames are returned in the CFB, with SIFS separation between the frames. If there is still time remaining in the TXOP 340, the media access controller 122 continues transmissions until the last frame 317 with the semaphore field 307a clear to logic ‘0’ arrives. The CFB is terminated after the frame 317 has been transmitted. The whole transmission time does not exceed the TXOP 340. Referring now to FIG. 3B, descriptors 302 through 308 are used to identify frames 312-318. In this case, each of the descriptors 302-308 has a semaphore field set to logic ‘1’. When the frame 312 arrives, the media access controller 122 contends for the physical medium and initiates a CFB after access to the physical medium. In FIG. 3B, the granted period, i.e. TXOP, is identified by reference numeral 340′. The media access controller 122 can track an actual amount of elapsed time from when the CFB begins. After the transmission of the first two frames 312 and 314, the granted period less the actual amount of elapsed time, i.e. the time remaining in the TXOP 340′, results in a time 335 not enough for the next frame 316 by examination of its exchange time field 306b. Therefore, the media access controller 122 terminates the CFB and then contends for the physical medium again. When gaining control of the medium, the media access controller 122 initiates another CFB for the frame 316 and subsequent frames. In view of the above, the software driver hosted on the processor 110 need not aggregate all frames for an entire CFB. The software driver only needs in real time to count the number of frames to be transmitted, calculate the frame duration, and determine whether the associated semaphore field should be set or not.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A contention-free burst method for a media access controller to transmit data over a network, comprising:
creating a plurality of descriptors identifying frames to be transmitted by a contention-free burst, each of the descriptors comprising a semaphore field and an exchange time field, in which the semaphore field indicates whether the frame associated therewith is the last one within the contention-free burst, and the exchange time field records a duration of the frame associated therewith;
successively transferring the frames to the media access controller;
the media access controller initiating the contention-free burst to transmit the frame identified by the first descriptor;
the media access controller continuing use of the contention-free burst to transmit subsequent frames identified by the corresponding descriptors;
the media access controller tracking an actual amount of elapsed time from when the contention-free burst is initiated; and
the media access controller terminating the contention-free burst, either when a granted period less the actual amount of elapsed time results in insufficient time for any remaining transmission according to the exchange time field of a current descriptor, or upon detecting a descriptor with a semaphore field indicating the last frame within the contention-free burst in which case termination is executed following transmission of the frame determined to be last.

2. The contention-free burst method of claim 1 further comprising:
sequentially setting the semaphore fields of the descriptors identifying the frames to be transmitted by the contention-free burst;
counting the number of the frames to be transmitted by the contention-free burst; and
upon the count reaching a predetermined number, clearing the semaphore field of the descriptor identifying the current frame.

3. The contention-free burst method of claim 1 further comprising:
sequentially setting the semaphore fields of the descriptors identifying the frames to be transmitted-by the contention-free burst;
calculating a cumulative sum of the frame durations recorded in the exchange time fields of the descriptors identifying the frames to be transmitted by the contention-free burst; and
upon the cumulative sum satisfying a predetermined condition, clearing the semaphore field of the descriptor identifying the current frame.

4. The contention-free burst method of claim 1 further comprising:
estimating the duration of each frame to be transmitted by the contention-free burst based on a physical data rate and the length of the frame; and
storing the estimated duration of each frame in the exchange time field of the corresponding descriptor.

5. A machine-readable medium having stored thereon data representing sequences of instructions for transmitting multiple frames over a network by a contention-free burst, and the sequences of instructions which, when executed by a processor, cause the processor to:
create a plurality of descriptors identifying the frames to be transmitted by the contention-free burst, wherein each of the descriptors comprises a semaphore field indicating whether the frame associated therewith is the last one within the contention-free burst, and comprises an exchange time field recording a duration of the frame associated therewith;
sequentially set the semaphore fields of the descriptors identifying the frames to be transmitted by the contention-free burst;
count the number of the frames to be transmitted by the contention-free burst;
calculate a cumulative sum of the frame durations recorded in the exchange time fields of the descriptors identifying the frames to be transmitted by the contention-free burst;
either upon the count reaching a predetermined number or when the cumulative sum satisfies a predetermined condition, clear the semaphore field of a descriptor identifying a current frame; and
successively transfer the frames to a media access controller for transmission of the frames using the contention-free burst.

6. The machine-readable medium of claim 5, wherein the duration of each frame to be transmitted by the contention-free burst is calculated from a physical data rate and the length of the frame.
